(19) United States
(12) Patent Application Publication
(10) Pub. No.: US 2003/0021397 A1
(43) Pub. Date: Jan. 30, 2003

(54) Policy based PC-to-phone text messaging for enterprise networks

(76) Inventor: Michael Wengrovitz, Concord, MA (US)

Correspondence Address: CHRISTIE, PARKER & HALE, LLP, 350 WEST COLORADO BOULEVARD, SUITE 500, PASADENA, CA, 91105, US

(21) Appl. No.: 10/207,286

(22) Filed: Jul. 29, 2002

Related U.S. Application Data
(60) Provisional application No. 60/308,371, filed on Jul. 27, 2001.

(51) Int. Cl. H04M 11/00

(52) U.S. Cl. 379/93.15

(57) ABSTRACT

A system for transmitting text messages over an enterprise network is disclosed. The system includes a network end device having a messaging application for constructing text message in a first format and a messaging server coupled to the network end device via the enterprise network for converting the text message from the first format to a second format. The messaging server may then forward text messages in the second format to a PBX via the enterprise network for transmitting the text message to one or more PBX phones. The messaging server may determine the PBX phones entitled to receive the message based on a stored policy rule.

### CROSS REFERENCE TO RELATED APPLICATION

This application claims priority of U.S. Provisional Patent application Ser. No. 60/308,371, entitled “POLICY BASED PC TO PHONE TEXT MESSAGING FOR ENTERPRISE NETWORKS,” filed Jul. 27, 2001, the content of which is incorporated herein by reference as if set forth in full.

### FIELD OF THE INVENTION

The present invention is generally related to text messaging systems and is more generally related to PC-to-phone text messaging systems.

### BACKGROUND

The interconnection of PCs and workstations into enterprise networks is becoming increasingly popular. Electronic mail (email) is an important part of networking activity. Email allows users to compose, send, and receive messages on their PCs or workstations over a network such as, for example, an enterprise network. Instant messaging systems have also been developed to facilitate real time communication between users. Instant messaging differs from email primarily in that its main focus is on immediate end-user delivery.

Conventional messaging within an enterprise network is typically based on PC-to-PC text messaging (e.g. email, instant messaging) or phone-to-phone voice/text messaging. Using a PC to send a short email message is common practice. However, many people receive hundreds of emails each day. Consequently, it may take a considerable amount of time before an email-based message is actually read by the recipient. For example, in many instances a recipient will typically have to sort through many other emails before reading the email containing the short but important message. In addition, given that many people work out of the office or travel to other sites during the day, the recipient may not receive the email-based short message until the next day.

Phone-to-phone voice/text messaging systems may also be used to facilitate communication between enterprise users. Private Branch Exchange (PBX)-based voice messaging systems automate the answering of incoming calls and the taking of messages when the extensions are not answered by the called parties. However, voicemail messages must be composed in real-time and changes or corrections are difficult to execute. Similarly, telephone-based text messaging systems where the user composes and reads text messages with the telephone keypad and display are often cumbersome to operate. In addition, making corrections, or changes, to the text message can be difficult.

Accordingly, there is a need for a messaging system that retains the advantages of the approach taken for PC-to-PC and phone messaging while discarding the limitations of each.

### SUMMARY OF THE INVENTION

The present invention is directed to a text messaging method that includes transmitting a text message in a first format from a network end device, converting the text message from the first format to a second format, transmitting the text message in the second format to a telephone switching device, and displaying the text message on a telephone.

According to one embodiment, the network end device is a personal computer and the first format is based on an internet protocol. In addition, the telephone switching device is a PBX unit and the second format is a based on a PBX protocol.

According to another embodiment, the text messaging method includes transmitting from a network end device a text message including a source address of the network end device and a destination extension of a telephone, checking whether the text message is authorized, and transmitting the text message to the telephone if the text message is authorized.

The invention is also directed to a system for transmitting text messages that includes a network end device, a server coupled to the network end device, a telephone switching device coupled to the server, and a telephone coupled to the telephone switching device. The network end device transmits a text message in a first format to the server, the server converts the text message from the first format to a second format and transmits the text message in the second format to the telephone switching device. In addition, the telephone switching device transmits the text message to the telephone for display thereon.

In a further embodiment, the network end device transmits to the server a text message including a source address of the network end device and a destination extension of the telephone. The server checks whether the text message is authorized and transmits the text message to the telephone for display thereon if the text message is authorized.

It should be appreciated, therefore, that the present invention allows generation of text messages via a PC and the receipt of those text messages via a PBX telephone. Thus, a sender of a text message may take advantage of the ease of generation of text messages provided by the PC while a recipient of the text message may make use of the automated answering and voice-mail capabilities provided by the PBX phone.

### BRIEF DESCRIPTION OF THE DRAWINGS

These and other features, aspects, and advantages of the present invention will become better understood with regard to the following description, appended claims, and accompanying drawings where:

FIG. 1 is a simplified block diagram of a PC-to-phone messaging system in accordance with an exemplary embodiment of the present invention;

FIG. 2 is a graphical illustration of a process for communicating a text message from a network end device to a digital or IP telephone in accordance with an exemplary embodiment of the present invention;

FIG. 3 is a screen capture of an exemplary graphical user interface for composing and sending text messages from a network end device to a digital or IP telephone in accordance with an exemplary embodiment of the present invention;

FIG. 4 is a screen capture of an exemplary graphical user interface for composing and sending multiple text messages from a network end device to a digital or IP telephone in accordance with an exemplary embodiment of the present invention; and

FIG. 5 is a simplified block diagram of a PC-to-phone messaging system having a messaging server coupled to a PBX for transmitting text messages to a phone in accordance with an exemplary embodiment of the present invention.

### DETAILED DESCRIPTION

An exemplary embodiment of the present invention comprises a hybrid PC-to-PC and PC-to-phone messaging system. The present invention is referred to as host-to-phone instant messaging and it retains the advantages found in email and instant messaging-based systems, such as simplicity in constructing and editing messages. Host-to-phone instant messaging has additional advantages of phone-based messaging systems such as recipient mobility and message alerts.

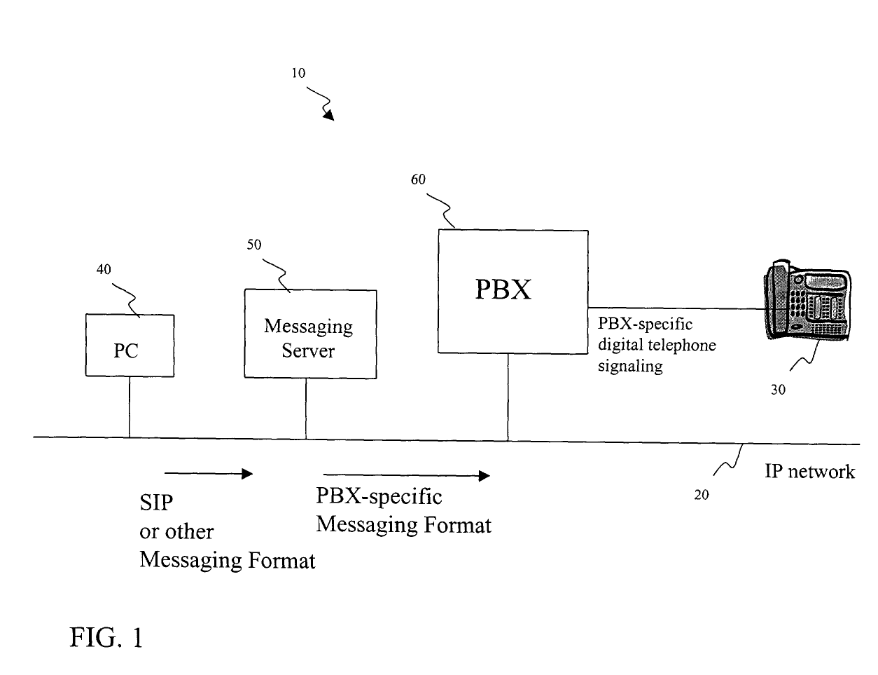

FIG. 1 is a schematic block diagram of a system 10 for providing PC-to-phone text messaging services for an internet protocol (IP) network 20. The system 10 may include a telephone 30 which may be a dedicated digital or IP telephony appliance that directly connects to a PBX 60 or connects to the PBX via the IP network 20. The PBX may be any type of telephone switching device conventional in the art.

The telephony appliance preferably includes a keypad, function buttons, handset, display, and a direct or network connection to the PBX 60. Unlike a general purpose PC with Internet telephony capabilities, the IP telephone 30 is a dedicated appliance that preferably incorporates the look and feel of a traditional telephone.

In accordance with an exemplary embodiment, a PC-based messaging application such as, for example, Windows messenger, or AOL's instant messenger may be used to construct a text message on a network end device, such as, for example, a PC 40. In the described exemplary embodiment the PC-based messaging application may utilize any one of a variety of IP telephony signaling protocols, such as, for example, the International Telecommunications Union (ITU) standard H.323 or Session Initiation Protocol (SIP) which describe how multimedia communications occur between terminals, network equipment and services on local area networks (LANs) and wide area networks (WANs). One skilled in the art will appreciate that the described exemplary text-based messages may be generated by any of a variety of network end devices according to any conventional communication protocol and is not limited to PC-based applications nor the IP telephony signaling protocol.

In accordance with an exemplary embodiment, a messaging client resident on the PC 40 may communicate the text message to a messaging server 50 via the IP network 20. The IP network may comprise for example an enterprise network that may include LANs, VLANS, circuit-switched networks and switches. In the described exemplary embodiment the messaging server 50 translates the text messages received from the PC 40 to any one of a variety of PBX protocols, such as, for example, computer supported telecommunications applications (CSTA), and transmits the PBX compatible text messages to the PBX 60 for invoking an action on the PBX 60. The PBX 60 in turn transmits the received text messages to the telephone via PBX-specific digital telephone signaling.

According to one embodiment of the invention, the messaging server 50 may be dedicated to a particular type of PBX. In another embodiment of the invention, the messaging server 50 functions with multiple types of PBXs, and is not limited to only one type.

In accordance with an exemplary embodiment of the present invention, the messaging server 50 may also provide additional services, such as allowing PC users to subscribe to one or more extensions, so that these are listed as buddies in the PC users' buddy list, or conversion between a buddy group (a single entry on the PC user's list) and constituent extensions. For example, a PC user may send a text message to a pre-defined group of individuals or entities. In the described exemplary embodiment, the messaging server converts between the group and individual members of the group. If the PBX 60 supports group messaging, (i.e. the PBX may simultaneously send a text message to more than one extension), the described exemplary messaging server converts a text message intended for a group of extensions to this format. If the PBX 60 does not support group messaging, the described exemplary messaging server 50 converts the group message to a sequence of individual messages which are then sent to the users.

In one embodiment, the messaging server 50 may route text messages in accordance with policy-based protocols stored in local memory. For example, the messaging server may restrict text message flow to a particular extension in accordance with a stored policy rule. In this embodiment, a particular extension may only accept text messages from a limited group of users and discard messages from other users or forward those messages to another extension. In another example, messages sent to one or more specific extensions may be logged and stored for backup and reference purposes.

In this embodiment, the messaging server may store destination extensions in a forwarding information database along with a corresponding list of source addresses from which text messages may be accepted. When the messaging server receives an incoming text message from a given one of its end devices, it sends the message up through the network interface physical layer to the application layer messaging server and then constructs a look-up key in accordance with the destination extension. The messaging server may then utilize an address matching algorithm to search the forwarding database for an entry corresponding to the destination extension. The messaging server may determine whether the extension accepts messages from the source address corresponding to the sending end device. If so, the text message is transmitted to the PBX for forwarding to the telephone set.

If the destination extension does not accept messages from the source address, the messaging server may discard the message or automatically forward the message to a different extension. In one embodiment, the messaging server may forward the text message to a particular extension in accordance with the source address.

One skilled in the art will appreciate that the described exemplary policy based text messaging service is not limited to routing policies based upon destination extensions or source addresses. Rather a number of different policies may be implemented to control various aspects of the operation of the messaging system. For example, policies may also be created to regulate which users can create buddy groups or what extensions may be included in the buddy groups. Therefore, the disclosed policy-based text messaging services are by way of example only and not by way of limitation.

One skilled in the art will further appreciate that the messaging server may be a stand-alone apparatus implemented in variety of manners. For example, the messaging server may comprise custom logic, e.g., application specific integrated circuits (ASICs), or may be implemented in software on a messaging server processor. In addition, although in the embodiment illustrated in FIG. 1, the PBX 60 and messaging server 50 are depicted as two separate components of the system, a person skilled in the art should recognize that the functionality of the two components may reside in a single IP-enabled PBX. Alternatively, the messaging server may also be implemented as a module within a computer telephony interface (CTI) server.

In the described exemplary embodiment, the PBX 60 may be a circuit switch that serves a community of terminals, such as telephones, facsimile machines, and computers. The PBX 60 may take the form of any conventional PBX unit existent in the art. The PBX 60 is preferably a generic PBX unit, and not a PBX unit customized to interact with a particular phone. The described exemplary PBX provides an inexpensive and convenient communication network among the community of terminals. In one embodiment the PBX may also be coupled to nodes in a public switched telephone network (PSTN), thereby providing communication paths to terminals outside the IP network.

An exemplary PBX may maintain point-to-point communication with the telephone 30 and communicate a number of different commands such as turn on message waiting light, enable ringer, present caller-id textual information on the set display, and the like. In one embodiment, the described exemplary PBX may encode a command in a text message to control a visual message waiting indicator on the telephone, for example an LED or a flashing LCD symbol, to notify the user at the extension of the existence of a message. Alternatively, the PBX may command the telephone set to generate an audible message waiting output when the PBX detects an off-hook condition on the extension to notify the user of the existence of a text message.

In accordance with an exemplary embodiment, text messages may be a specific type of message sent by the PBX 60 to the telephone 30. In one embodiment, an exemplary text message may include a corresponding message ID, along with ASCII, binary, or encoded information in the text message. In an exemplary embodiment, the PBX may forward digital time domain based text messages or IP based text messages as appropriate to the telephone sets.

An exemplary telephone set may display the number of unconsulted text messages. A user may then scroll through the received text messages, displaying them in a conventional manner.

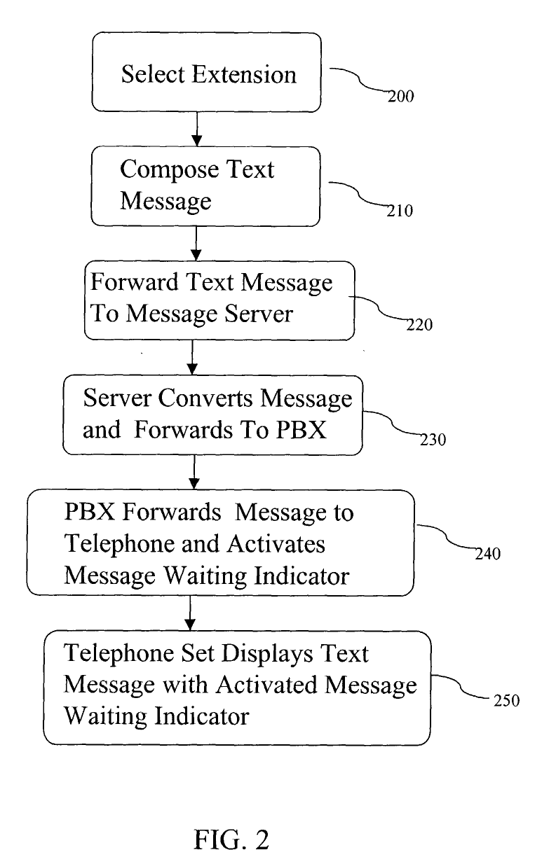

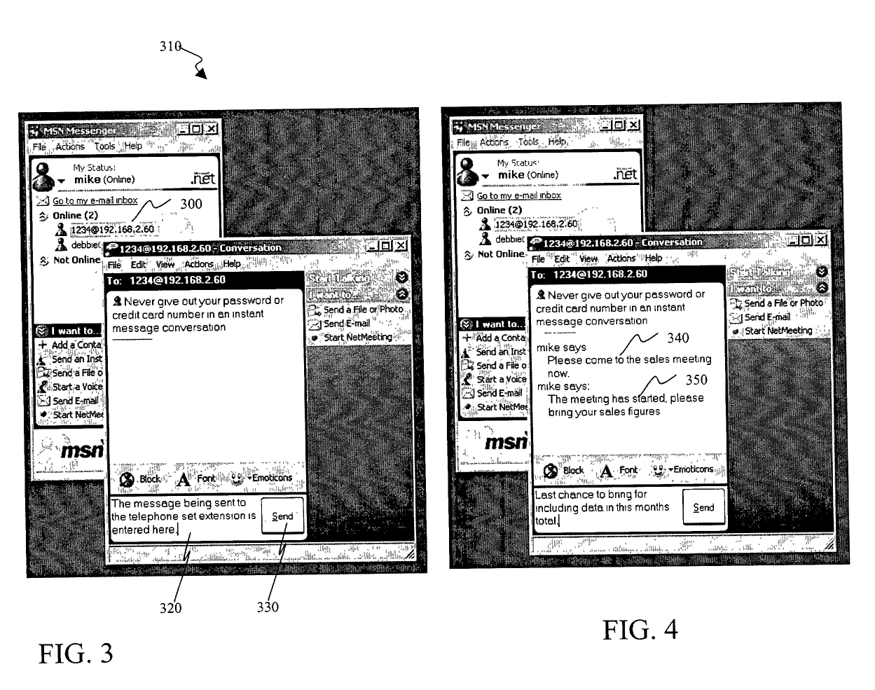

FIG. 2 is a flow diagram of a process for communicating a text message to a PBX telephone according to one embodiment of the invention. In accordance with an exemplary process, a user of the text messaging service may select an extension or a destination address 200. This may be accomplished, for instance, by selecting an extension 300 (e.g. 1234 in this example) stored in an address book or buddy list on a graphical user interface 310 (see FIG. 3). In accordance with an exemplary embodiment, a user may compose a text message 210 in a text box 320 (see FIG. 3) of the graphical user interface. The user may forward the text message to the intended recipient 220 by clicking on a send button 330 on the graphical user interface (see FIG. 3).

In addition, in one embodiment, a user may compose multiple messages 340 and 350 from the same user interface (see FIG. 4). Further, if the PBX supports message queuing, multiple text messages may be delivered and sequentially read by the recipient in the order they were received.

In the described exemplary embodiment the messaging server receives text message from the end device over the IP network. The messaging server translates the text message to a PBX command and forwards the PBX command to the PBX 230. In an exemplary embodiment, the messaging server may convert a message intended for a group designated by a single entry on the PC user's buddy list to multiple messages for each of the constituent extensions. The PBX receives the command and forwards the text message to each intended recipient 240. The received message may then be displayed on the telephone set, and a message waiting indicator on the appropriate telephone set may then be activated 250.

The described exemplary text messaging service may also be utilized to deliver PC-phone text message over restricted access networks such as for example, a virtual local area network (VLANs) within an institutional or enterprise network. VLANs are sub-networks which typically include a plurality of network devices, such as servers, workstations and PCs, that together form a logical work group within a larger network. In practice VLAN membership is assigned based on policies rather than physical location in the network. In addition, network bandwidth is often conserved and network security enhanced by assigning VLAN membership based on considerations of efficiency and need and restricting the flow of network traffic across VLAN boundaries.

Returning to FIG. 1, in this embodiment, a text message constructed on the network end-station 40 such as a workstation, PC, or other systems having a user interface may be transmitted on an enterprise network, which may include LANS, VLANs, circuit-switched networks and switches, to the telephone 30 whereon the text message is displayed.

In this embodiment, a VLAN check is performed on the text message prior to completing the transmission. For example, in one embodiment, the messaging server 50 may perform a VLAN check to verify the network end-station 40 is authorized to communicate with the destination extension prior to forwarding the message. For example, VLAN membership may be assigned by comparing the text message with a configured set of rules which classify the message, and by inference the system which originated the message, into one or more VLANs. The VLAN into which the message is classified may then be checked against a list of VLANs to which the destination extension belongs to determine whether the message is authorized to be forwarded.

In the described exemplary embodiment, the messaging server 50 may translate privileged text messages to PBX commands and forward the PBX commands to the PBX 60 for communication to the telephone 30.

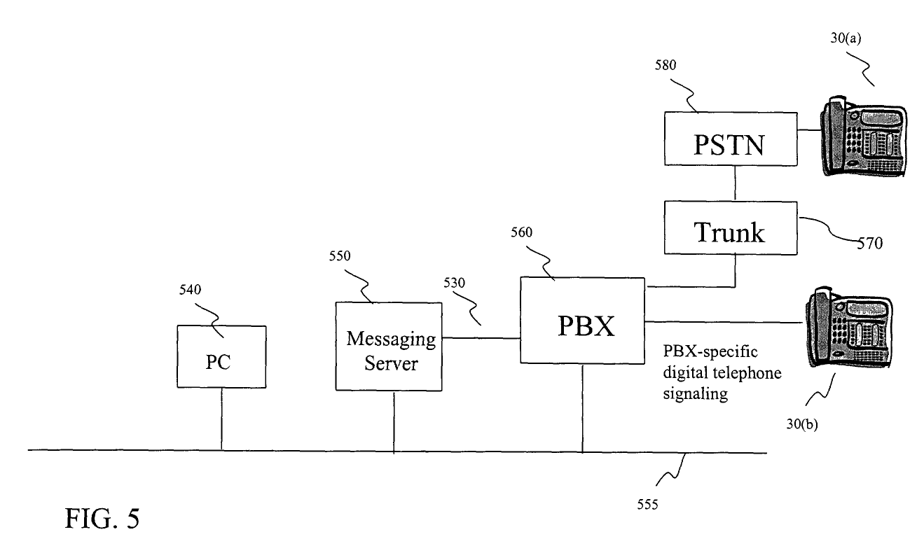

One of skill in the art will appreciate that the present invention is not limited to systems having a PBXs coupled to an IP network. Rather, referring to the simplified block diagram of FIG. 5, in another embodiment of the present invention a messaging client resident on a network end device, such as for example a PC 540 and may communicate text messages to a messaging server 550 by an IP network 555. In the described exemplary embodiment the messaging server 550 translates the text messages received from the PC to any one of a variety of PBX protocols, and transmits the PBX compatible text messages to the PBX 560 over a serial port interface, or over an interface which emulates a digital phone 530 for invoking an action on the PBX 560.

In the described exemplary embodiment the PBX 560 may be a circuit switch that serves a community of terminals, such as telephones, facsimile machines, and computers. In this embodiment the PBX 560 may not be IP compatible and preferably supports phone to phone text messaging, and the messaging server substantially emulates the operation of phones 30a-30b. In one embodiment, the PBX may also be coupled to nodes 570 in the public switched telephone network (PSTN) 580, thereby providing communication paths to terminals outside the distributed PBX system.

Although an exemplary embodiment of the present invention has been described, it should not be construed to limit the scope of the appended claims. Those skilled in the art will understand that various modifications may be made to the described embodiment and that numerous other configurations are capable of achieving this same result. Moreover, to those skilled in the various arts, the invention itself herein will suggest solutions to other tasks and adaptations for other applications. It is the applicants intention to cover by claims all such uses of the invention and those changes and modifications which could be made to the embodiments of the invention herein chosen for the purpose of disclosure without departing from the spirit and scope of the invention.

What is claimed is:

1. A text messaging method comprising:
transmitting a text message in a first format from a network end device;
converting the text message from the first format to a second format;
transmitting the text message in the second format to a telephone switching device; and
displaying the text message on a telephone.

2. The method of claim 1, wherein the first format is based on an internet protocol.

3. The method of claim 1, wherein the second format is based on a PBX protocol.

4. The method of claim 1, wherein the network end device is a personal computer.

5. The method of claim 1, wherein the telephone switching device is a PBX unit.

6. The method of claim 1, wherein the transmitting of the text message to the telephone switching device comprises transmitting the text message in accordance with a stored policy rule.

7. The method of claim 5, wherein the policy rule restricts a recipient of the text message to one or more telephone extensions.

8. The method of claim 1 further comprising alerting a user of the telephone of the text message.

9. The method of claim 1, wherein the text message is an instant message.

10. A system for transmitting text messages comprising:
a network end device;
a server coupled to the network end device;
a telephone switching device coupled to the server; and
a telephone coupled to the telephone switching device, characterized in that the network end device transmits a text message in a first format to the server, the server converts the text message from the first format to a second format and transmits the text message in the second format to the telephone switching device, further characterized in that the telephone switching device transmits the text message to the telephone for display thereon.

11. The system of claim 10, wherein the first format is based on an internet protocol.

12. The system of claim 10, wherein the second format is based on a private branch exchange protocol.

13. The system of claim 10, wherein the network end device is a personal computer.

14. The system of claim 10, wherein the telephone switching device is a PBX unit.

15. The system of claim 10 further characterized in that the server transmits the text message to the telephone switching device in accordance with a stored policy rule.

16. The system of claim 15, wherein the policy rule restricts the text message to one or more telephone extensions.

17. The system of claim 10, further characterized in that the a user of the telephone is alerted of the text message.

18. The system of claim 10, wherein the text message is an instant message.

19. A text messaging method comprising:
transmitting from a network end device a text message including a source address of the network end device and a destination extension of a telephone;
checking whether the text message is authorized; and
transmitting the text message to the telephone if the text message is authorized.

20. The text messaging method of claim 19, wherein the checking step includes determining whether the network end device is authorized to communicate with the telephone.

21. The text messaging method of claim 19, wherein the checking step includes determining whether the source address is authorized to communicate with the destination extension.

22. The text messaging method of claim 19, wherein the checking step includes a VLAN check.

23. The text messaging system of claim 22, wherein the VLAN check includes determining whether the network end device and the telephone participate in a common VLAN.

24. A system for transmitting text messages comprising:
a network end device;
a server coupled to the network end device;
a telephone coupled to the server, characterized in that the network end device transmits to the server a text message including a source address of the network end device and a destination extension of the telephone, the server checks whether the text message is authorized and transmits the text message to the telephone for display thereon if the text message is authorized.

25. The system of claim 24, wherein a telephone switching device is coupled between the server and the telephone for relaying the text message from the server to the telephone if the text message is authorized.

26. The text messaging method of claim 24, wherein the text message is authorized if the network end device is authorized to communicate with the telephone.

27. The text messaging method of claim 24, wherein the text message is authorized if the source address is authorized to communicate with the destination extension.

28. The text messaging method of claim 24, wherein the text message is authorized if the text message passes a VLAN check.

29. The text messaging system of claim 28, wherein the VLAN check includes determining whether the network end device and the telephone participate in a common VLAN.
